(19) United States
(12) Patent Application Publication
(10) Pub. No.: US 2013/0027929 A1
(43) Pub. Date: Jan. 31, 2013

(54) Exchangeable Multi-Lensing System for Multi-Application LED Lighting

(71) Applicant: George Erik McMillan, Hickory, NC (US)

(72) Inventor: George Erik McMillan, Hickory, NC (US)

(21) Appl. No.: 13/558,493

(22) Filed: Jul. 26, 2012

Related U.S. Application Data
(60) Provisional application No. 61/512,453, filed on Jul. 28, 2011.

(51) Int. Cl. F21V 5/04

(52) U.S. Cl. 362/235

(57) ABSTRACT

There is provided an LED light fixture including a housing adapted to be mounted a predetermined height above a surface. The housing includes at least one LED emitter situated so as to emit light toward the surface below the housing. A first lens plate is provided and is removably attached to the housing. The first lens plate has a first opening therein and a first lens having a first angle of light dispersion is received in the opening. The opening of the first lens plate is aligned with the LED emitter so that the first lens controls the footprint of the pattern of light from the LED emitter which impinges upon the surface.

### RELATION TO PRIOR APPLICATION

This is a U.S. non-provisional application relating to and claiming the benefit of U.S. Provisional Patent Application Ser. No. 61/512,453 filed Jul. 28, 2011.

### BACKGROUND

Light emitting diode (LED) lighting systems are becoming more and more popular because of their efficiency and lifespan advantages over more traditional lighting systems such as incandescent, fluorescent and HID lighting systems. An LED light source is easier to control as it is directional. Instead of emitting three hundred sixty degrees as all previous light sources, LEDs emit light in one direction in patterns of ninety to one hundred forty-five degrees. However, all lights including LEDs have undesirable excessive amounts of waste light in certain situations. Waste light is light dispensed where it is not needed or is usable. This is the case with all lights when mounted high as with bay lights. Bay lights disperse some of their light at side angles at heights where it is not usable. It would be advantageous to have a method of controlling light which is normally emitted to the fixtures' sides and redirect it downward, thus minimizing this loss of light and energy. For example, with a twenty-five foot average ceiling height, four hundred watt metal halide fixtures spaced every thirty feet from one another are usually all that is necessary for proper lighting. If the ceiling height is forty-eight feet, usually it requires a six hundred watt or one thousand watt replacement, or a dual head four hundred watt system to replace the individual four hundred watt fixtures so as to obtain the same light to illuminate the same area due to the “waste light” loss. In most cases, fixtures must be set closer to one another for the same reason to create the needed light level.

With existing lighting marketed for years, such as incandescent, quartz, fluorescent and HID (sodium, mercury, metal halide), optimal control could only be adjusted by utilizing a means of reflectors as all the previous light systems emit light within a three hundred sixty degree circumference and the shape of the bulbs and tubes does not lend to accurate light dispersion. Thus, various fixtures at varying power levels were required for different light heights and distribution coverages. With the more controllable LED technology, newly introduced to commercial lighting, it is possible to provide more accurate light dispersion.

As LEDs are directional (not three hundred sixty degrees), it is possible to develop the LEDs/LED arrays with lensing molded to the LED emitter itself and, in some cases, small lenses or reflectors can be mounted to the LED board. This is somewhat of a step forward. With these methods, light dispersion is much more controllable, however, it produces the same restriction as earlier reflector systems with previous lights as, once the lens or reflector is mounted to the LED, it is now limited to a certain angle of light output and height.

### SUMMARY OF THE INVENTION

In accordance with one form of this invention there is provided an LED light fixture including a housing adapted to be mounted at predetermined heights above a surface. The housing includes at least one LED emitter. The LED emitter is situated so as to emit light toward the surface. A first lens plate is provided and is removably attached to the housing. There is at least one opening in the first lens plate. A first lens is received in the opening. The opening of the first lens plate is aligned with the LED emitter whereby the first lens controls the angle of light dispersion of the light from the LED emitter and the footprint of the pattern of light which impinges on the surface. Preferably the housing includes a plurality of LED emitters and the lens plate includes a plurality of openings and lenses.

Preferably, a second lens plate is included having a second lens with a different angle of light dispersion from the first lens. The first lens plate is replaced by the second lens plate when the housing is mounted at a height above the surface which is different from the first predetermined height.

In accordance with another form of this invention there is provided a method for providing a substantially uniform light pattern from a light fixture having at least one LED emitter for various mounting heights of the fixture. The light fixture further includes a housing and a first lens plate. The first lens plate has at least one opening and a first lens having a first angle of light dispersion is received in the opening. The first lens is adjacent to the LED emitter. The method includes mounting the fixture at a first distance above a surface; energizing the LED emitter wherein light is emitted through the first lens and forms a light pattern on the surface having a predetermined footprint; removing the first lens plate from the light fixture; and replacing the first lens plate with a second lens plate. The second lens plate has at least one opening therein and a second lens having a second angle of light dispersion is received in the opening. The second lens is adjacent to the emitter. The method further includes mounting the fixture at a second predetermined distance above the surface; and energizing the LED emitter wherein light is emitted through the second lens and forms a light pattern on the surface having a footprint substantially equal to the first predetermined footprint.

In yet another form of this invention there is provided an LED lighting system including a light fixture with a housing. The housing includes an emitter plate having at least one LED emitter mounted thereon. A first lens plate having at least one opening therein is provided. A first lens having a first angle of light dispersion is mounted in the opening in the first lens plate. A second lens plate having at least one opening therein is also provided. A second lens having a second angle of light dispersion is mounted in the opening in the second lens plate. The light fixture is mountable at various heights above a surface. The first lens plate is attached to the housing for a first predetermined height above the surface. The first lens is located adjacent to the LED emitter wherein a light pattern having a predetermined footprint is formed on the surface. The second lens plate is attached to the housing for the second predetermined height above the surface. The second lens is located adjacent to the LED emitter wherein a light pattern having substantially the same predetermined footprint is formed on the surface.

### BRIEF DESCRIPTION OF THE DRAWINGS

The subject matter which is regarded as the invention is set forth in the claims. The invention, however, may be better understood in reference to the accompanying drawings in which:

FIG. 1 is a partially exploded perspective view showing one embodiment of the subject invention.

FIG. 2 is an inverted partial perspective view showing a portion of the embodiment of FIG. 1 in more detail.

FIG. 3 is a side elevational view of several lenses which may be used with the lens plate of the embodiment of FIG. 1.

FIG. 4 is a side elevational view of a portion of the embodiment of FIG. 1.

FIG. 5 is a schematic illustration showing the relationship between the angle of light dispersion of various lenses and various fixture heights above a surface.

FIG. 6 illustrates the overlap of the light patterns on a surface using four fixtures.

### DESCRIPTION OF THE PREFERRED EMBODIMENTS

This invention enables the control of light patterns using a single light fixture for many applications and for various heights. The fixture includes a removable lens plate which is populated with individual optic or dome lenses which are mounted in line with LED emitters which in turn are mounted on an emitter plate located within the light fixture. The invention enables the lens plate to incorporate multiple lenses, all with the same angle of light dispersion, to accurately control the exact light coverage or footprint as well as the intensity of the light in a specific area at a given height. An identical lens plate can also be utilized with dome type lenses to disperse the light further to the sides which is particularly useful in a low ceiling application since the light intensity is not as critical directly below the fixture in a low mounting position. The lens plate can also be populated with a mix of various lenses, including a mix of optic lenses and dome lenses for other custom applications. This allows for a single fixture to be utilized in a wide array of lighting circumstances. Appropriate optical lenses are commercially available from LED World. Appropriate dome lenses are commercially available from Ximenwerun Technology Corp.

The lens plate not only allows for a multitude of applications of a single fixture, it also allows for the same fixture to be relocated in various areas at various heights simply by exchanging the lens plate alone without a substantial change in the lighting pattern or light intensity. For example, at a thirty foot height, a ninety-five watt LED bay fixture having sixty degree light dispersion individual optic lenses within a lens plate can replace a four hundred watt metal halide fixture. At a twenty foot height, the LED fixture may best be suited with individual ninety degree light dispersion optic lenses to optimize the light output. Finally at twelve to fifteen foot heights, one could use dome lenses within the lens plate of the LED fixture. In addition, at twelve to fifteen foot heights, a combination of one hundred twenty degree light dispersion optic lenses, mixed with dome lenses, may be the optimal choice to acquire the desired light coverage. Most any degree and spread of light combination or degree of coverage can be achieved easily, with very little time and effort, simply by replacing the lens plate, using any number of individual optic or dome lenses, or any combination thereof, within the lens plate to precisely control the light emission in any area and in any situation by using a single fixture.

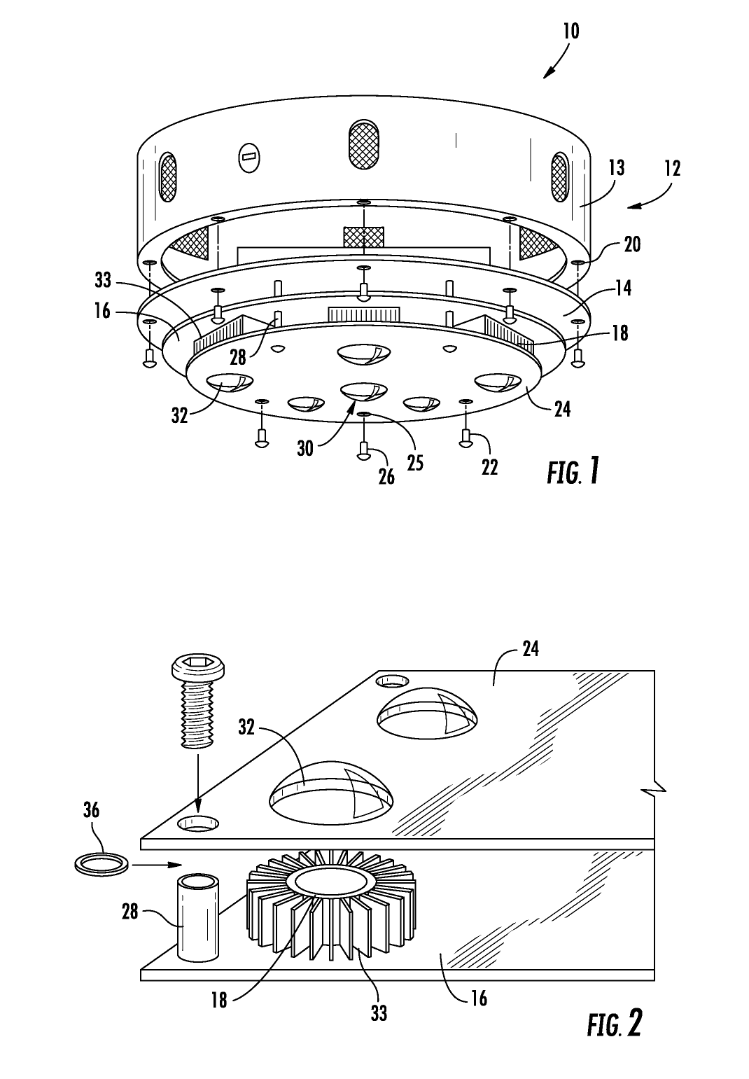

Referring now more particularly to FIG. 1, there is provided LED light fixture 10 having a housing 12. Housing 12 includes main housing 13, mounting plate 14, and emitter plate 16. Mounting plate 14 is attached to main housing 13 which attaches to a ceiling (not shown). A plurality of LED emitters 18 and associated heat sinks 34 are mounted on emitter plate 16. In the embodiment of FIG. 1, there are six LED emitters. There is a plurality of holes 20 in main housing 13 used for mounting the lower fixture to main housing 13. Holes 25 are for attaching lens plate 24 to emitter plate 16 through holes via spacers 28 using spacer screws 22. The mounting screws pass through holes in both the emitter plate 16 and mounting plate 14. Thus, the mounting plate 14 and emitter plate 16 are secured to the main housing 13. Lens plate 24 is removably attached to emitter plate 16 by screws 26. A plurality of stand-off spacers 28 maintains a predetermined distance between lens plate 24 and emitter plate 16. Lens plate 24 includes six openings 30 therein. Each opening receives lens 32. Stand-off spacer 28 also maintains a predetermined distance between LED emitter 18, mounted on heat sink 33, and optic lens 32. Preferably this spacing between LED emitter 18, mounted on heat sink 33, and lens 32 is five millimeters for optic lenses. Preferably, for a dome type lens such as dome lens 34 shown in FIG. 4, the LED emitter 18 penetrates to the inside of the dome. Dome lens 34 surrounds LED emitter 18. As can be seen in FIG. 2, a shim 36 may be provided and located between the top of spacer 28 and emitter plate 16 to increase the distance between the LED emitter 18 and lens 32 so as to change the angle of light even further. In the preferred embodiment, emitter 18 is attached to heat sink 33 which, in turn, is attached to emitter plate 16. Emitter 18 may also be attached to a circuit board (not shown). The combination of emitter 16 and heat sink 33 is often referred to as an LED module.

As previously indicated, lenses having various angles of light dispersion may be used with lens plate 24 depending on the height that the fixture is placed above the surface, such as the ground or the floor of a building. For example, lens 32 may be hollow dome lens 34 which has a light dispersion of more than one hundred eighty degrees and in addition, the inside of the lens is frosted so as to evenly diffuse the light. This hollow dome lens is particularly adapted for use at lower levels. In addition as shown in FIG. 4, by using a hollow dome lens which has been internally frosted, a limited amount of light disperses upwardly towards the ceiling which eliminates the cave effect.

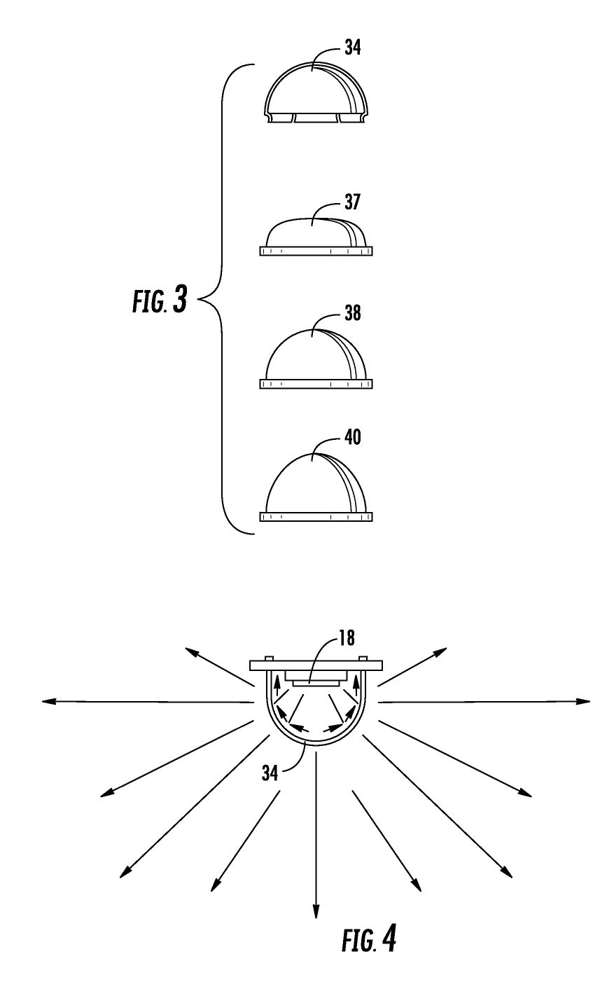

Lens 32 may be any of a number of lenses having various light dispersions such as lens 34, 37, 38 and 40 shown in FIG. 3. Lens 37, which is a solid optical lens, has a light dispersion of ninety degrees and is ideal for heights above the surface of fifteen to twenty feet. Lens 38 is also a solid optical lens and has light dispersion of sixty degrees which makes it ideal for ceiling heights of eighteen feet to thirty-five feet. Lens 40 is also a solid optical lens and has a forty-five degree light dispersion and is ideal for ceiling heights of thirty to fifty feet. The difference in the light dispersion is accomplished by using lenses with different radii of curvature, as well as shim 36.

Individual lenses may be replaced on the lens plate 24 to achieve optimum lighting for the surface, such as the floor. However, it is preferred that a lens plate having lenses with the same light dispersion be replaced with a lens plate having lenses with different light dispersions when it is desired to mount the fixture 10 at a different height above a surface. By using removable screws 26, the replacement of a lens plate is made easy. Thus, by merely replacing a lens plate, the fixture may be used at different heights to provide the same lighting footprint for a given area of a surface such as a floor. This is best illustrated in reference to FIG. 5.

FIG. 5 shows fixture 10 which is mounted at various levels above surface 42, which in this embodiment is a floor. Also in this embodiment, fixture 10 is mounted to a ceiling.

FIG. 5 shows five angles of light dispersion, 44, 46, 48, 50 and 52, each representing a lens plate having lenses with a particular light dispersion. Line 44 illustrates use of a lens, such as dome lens 34, having a light dispersion of more than one hundred eighty degrees mounted twelve feet above the floor 42(a). Line 46 illustrates use of lens 37 having a light dispersion of ninety degrees with an elevation of fifteen feet above the floor. Line 48 represents use of a lens having a seventy degree light dispersion with the fixture being twenty feet above the floor. Line 50 represents a thirty-four degree light dispersion with the fixture mounted forty feet above the floor. Line 52 represents use of a lens having a twenty-two degree light dispersion where the fixture is mounted sixty feet above the floor. All of these lenses and fixture mounting heights provide a fifteen foot footprint of light on the floor. While there is some loss of light intensity at higher levels, the loss is not significant with this method.

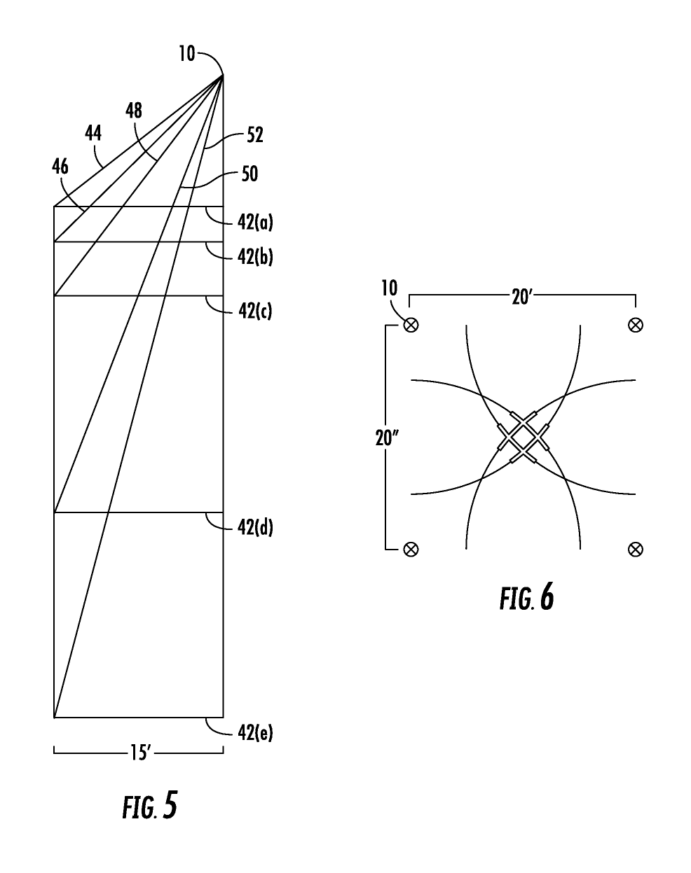

FIG. 6 illustrates the overlap of floor lighting when using four ceiling mounted fixtures 10 located twenty feet apart. Other lighting fixtures in addition to indoor bay lights may be used, such as street lights. A preferred method for providing a substantially uniform lighting pattern from a light fixture for various mounting heights is set forth below.

The fixture is first mounted a predetermined distance above a surface. The LED emitters are energized so that light is emitted through lenses in the first lens plate and forms a lighted pattern on the surface having a predetermined footprint. The first lens plate is removed from the light fixture and replaced with a second lens plate. The second lens plate is substantially the same as the first plate except that it is populated with lenses having a different angle of light dispersion from the lenses of the first lens plate. The fixture is then mounted a second distance above the surface. The LED emitters are energized so that the light is emitted through the second lens plate and forms a lighted pattern on the surface having a footprint which is substantially equal to the first predetermined footprint.

While the invention has been described in terms of the above embodiments, those skilled in the art will recognize that the invention can be practiced with modification within the spirit and scope of the appended claims.

1. An LED light fixture comprising:
a housing adapted to be mounted a predetermined height above a surface;
the housing including at least one LED emitter; the LED emitter situated so as to emit light towards the surface below the housing;
a first lens plate; the first lens plate removably attached to the housing; at least one opening in the first lens plate;
a first lens having a first angle of light dispersion received in the opening; the opening of the first lens plate aligned with the LED emitter whereby the first lens controls the footprint of the pattern of light from the LED emitter which impinges upon the surface.

2. A light fixture as set forth in claim 1 further including a second lens plate having an opening therein; a second lens received in the opening of the second lens plate; the angle of light dispersion of the second lens being different from the angle of light dispersion of the first lens; the first lens plate being readily replaceable with the second lens plate whereby upon replacement of the first lens plate with the second lens plate, the opening in the second lens plate aligns with the LED emitter.

3. A light fixture as set forth in claim 2 wherein the first lens plate is attached to the housing for a first predetermined height of the fixture above the surface and the second lens plate is attached to the housing for a second predetermined height of the fixture above the surface; the first predetermined height being different from the second predetermined height; the pattern of light which impinges on the floor having substantially the same footprint using the first lens plate and the second lens plate.

4. A light fixture as set forth in claim 2 further including a plurality of LED emitters; each lens plate having a plurality of openings; a lens received in each opening; each opening aligns with an LED emitter.

5. A light fixture as set forth in claim 4 wherein the angle of light dispersion for each lens on a particular lens plate is substantially the same.

6. A light fixture as set forth in claim 4 wherein the angle of light dispersion for at least one lens on a particular lens plate is different from the angle of light dispersion for at least one of the other lenses on that particular lens plate.

7. A light fixture as set forth in claim 1 wherein the LED emitter is mounted on an emitter plate; the lens located a predetermined distance from the LED emitter.

8. A light fixture as set forth in claim 7 wherein the emitter plate is connected to the lens plate; at least one stand-off spacer located between the emitter plate and the lens plate for establishing the predetermined distance between the lens and the LED emitter.

9. A light fixture as set forth in claim 8 further including a shim removably connected to the stand-off spacer for changing the predetermined distance between the lens and the LED emitter.

10. A method for providing a substantially uniform light pattern from a light fixture having at least one LED emitter for various mounting heights for the fixture comprising:
providing a light fixture having a housing including at least one LED emitter; providing a first lens plate; the first lens plate having at least one opening; a lens having a first angle of light dispersion received in the opening of the first lens plate; the first lens adjacent to the LED emitter;
mounting a fixture a first distance above a surface;
energizing the LED emitter wherein light is emitted through the first lens and forms a light pattern on the surface having a predetermined footprint;
removing the first lens plate from the light fixture;
replacing the first lens plate with a second lens plate; the second lens plate having at least one opening therein; a second lens having a second angle of light dispersion received in the opening of the second lens plate; the second lens being adjacent to the LED emitter;
mounting the fixture a second distance above the surface;
energizing the LED emitter wherein light is emitted through the second lens and forms a light pattern on the surface having a footprint substantially equal to the first predetermined footprint.

11. A method as set forth in claim 10 further including controlling the distance between the LED emitter and the first lens; and controlling the distance between the LED emitter and the second lens.

12. A method as set forth in claim 11 wherein the distance between the emitter and the first lens is substantially the same as the distance between the LED emitter and the second lens.

13. A method as set forth in claim 11 wherein the distance between the LED emitter and the first lens is different from the distance between the LED emitter and the second lens.

14. A method as set forth in claim 10 further including calculating the angle of light dispersion for the first lens to provide the predetermined footprint of the light pattern on the surface for the first distance of the fixture above the surface; selecting a lens having the appropriate angle of light dispersion for the first lens plate; calculating the angle of light dispersion for the second lens to provide a light pattern having a footprint substantially equal to the footprint of the predetermined footprint for the second distance of the fixture above the surface; selecting a lens having the appropriate angle of light dispersion for the second lens plate.

15. A method as set forth in claim 14 further including adjusting the distance between the LED emitter and the second lens wherein the predetermined footprint of the light pattern will be substantially the same for the first and second lens plates.

16. An LED lighting system comprising:
a light fixture including a housing;
the housing including an emitter plate having at least one LED emitter mounted thereon;
a first lens plate having at least one opening therein;
a first lens having a first angle of light dispersion mounted in the opening in the first lens plate;
a second lens plate having at least one opening therein;
a second lens having a second angle of light dispersion mounted in the opening in the second lens plate;
the fixture being mountable at various heights above a surface; the first lens plate attached to the emitter plate for a first height above the surface; the first lens located adjacent to the LED emitter wherein a light pattern having a predetermined footprint is formed on the surface;
the second lens plate attached to the emitter plate for a predetermined height above the surface; the second lens located adjacent to the LED emitter wherein a light pattern having a footprint substantially equal to the predetermined footprint is formed on the surface.

17. A system as set forth in claim 16 further including at least one spacer located between the emitter plate and the first and second lens plates for maintaining a fixed distance between the LED emitter and the first and second lenses.

18. A system as set forth in claim 17 further including a shim removably attached to the spacer for adjusting the distance between the LED emitter and the first and second lenses.

19. A system as set forth in claim 17 wherein the first lens plate has a plurality of lenses; each of the plurality of lenses having the same angle of light dispersion.

20. A system as set forth in claim 17 wherein the first lens plate has a plurality of lenses; at least one of the plurality of lenses having a different angle of light dispersion from at least one other of the plurality of lenses.
